(19) United States
(12) Patent Application Publication
(10) Pub. No.: US 2007/0035657 A1
(43) Pub. Date: Feb. 15, 2007

(54) Imaging system

(76) Inventor: Katsumi Oosawa, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/501,986

(22) Filed: Aug. 10, 2006

(30) Foreign Application Priority Data
Aug. 11, 2005 (JP) P2005-233076

(51) Int. Cl. H04N 7/173; H04N 5/225

(52) U.S. Cl. 348/373; 725/105

(57) ABSTRACT

Disclosed herein is an imaging system including a stationary base, an imaging device that is rotatably attached to the stationary base, and a rotary coupling unit that electrically couples the stationary base and the imaging device, wherein an analog luminance signal and an analog color signal are used for transmission of a video signal, and are transmitted through different transmission paths in the rotary coupling unit.

### CROSS REFERENCES TO RELATED APPLICATIONS

The present invention contains subject matter related to Japanese Patent Application JP 2005-233076 filed in the Japanese Patent Office on Aug. 11, 2005, the entire contents of which being incorporated herein by reference.

### BACKGROUND OF THE INVENTION

1. Field of the Invention

One embodiment of the invention relates to an imaging system that employs a rotary coupling unit to electrically couple a stationary base and an imaging device.

2. Description of the Related Art

In a camera system having an endless rotary mechanism, a rotary coupling unit (hereinafter, referred to as a slip ring) is frequently used for signal transmission from an imaging device as a movable device to a rotation base as a stationary body.

A typical slip ring is formed of a rotary shaft part in which a collector ring is attached to a rotary shaft, and a fixed part in which brushes and terminals are connected to a fixed case. The brushes are in sliding contact with the outer circumferential surface of the collector ring. Specifically, at the time of the rotation of the movable device, the brushes can move on the outer circumferential surface of the collector ring in such a manner as to slide thereon with being in contact therewith.

One pair of the collector ring and brush serves as one transmission path. As many pairs of the collector ring and brush as the number of transmission paths required in the slip ring are provided, and these pairs are electrically independent of each other. Typically, the number of the pairs of the collector ring and brush is referred to as the number of poles.

The imaging system with an endless rotary mechanism has a wide application range, and is applied also to the network camera field in recent years.

In an imaging system having a network function, video signals necessary for signal processing are transmitted in a digital signal format in general.

However, in order to allow the passage of video signals in a digital signal format through a slip ring, a large number of poles are required. For example, the number of poles necessary for the video signals is three.

Accordingly, in general, a method in which signals in an analog composite video signal format are transmitted through a slip ring is employed. In this method, the number of poles for transmission of the video signals may be one.

FIG. 1 illustrates an example of the imaging system that employs an analog composite video signal method (method of using combined luminance and color signals as a composite signal) as the transmission method in the slip ring part.

This imaging system includes a stationary base 1, an imaging device 3 that is rotatably attached to the stationary base, and a slip ring 5 that electrically couples the stationary base and the imaging device.

In the case of this transmission method, the number of poles in the slip ring 5 is five. Therefore, this transmission method is advantageous over the method of transmitting signals in a digital signal format in terms of costs.

An analog composite video signal is separated into a luminance signal Y and a color signal C by a YC separator 11 incorporated in the stationary base 1, followed by being supplied to a decoder 13.

Examples of related art documents include Japanese Patent Laid-opens No. Hei 7-37668 and No. 2004-253963.

### SUMMARY OF THE INVENTION

As described above, the method of transmitting signals in an analog composite video signal format through the slip ring 5 is effective for reducing the number of poles. However, this method involves a problem in that the image quality is deteriorated due to YC mixing (i.e., cross color). This problem precludes effective use of the imaging ability of a camera block 31.

Therefore, a method of employing an optical transmission path for video signal transmission would be available.

FIG. 2 illustrates an example of an imaging system including a slip ring 50 that uses light for video signal transmission.

In this system, a camera block 31 outputs video signals in a digital signal format in parallel. Therefore, an imaging device 30 is provided with an S/P converter 37 that converts parallel data into serial data, and an optical modulator 39 that converts an electric signal into an optical signal. Furthermore, a stationary base 10 is provided with an optical receiver 101 that converts a received optical signal into an electric signal, and an S/P converter 103 that converts serial data into parallel data.

However, the method of using light for video signal transmission involves fear of an increase in manufacturing costs.

In order to solve the above-described problems, the present inventor proposes an imaging system including a stationary base, an imaging device that is rotatably attached to the stationary base, and a rotary coupling unit that electrically couples the stationary base and the imaging device. In this imaging system, an analog luminance signal and an analog color signal are used for transmission of a video signal, and these two signals are transmitted through different transmission paths in the rotary coupling unit.

If the transmission method according to the invention is employed in a slip ring part, video signals can be transmitted with being separated into analog luminance signals and analog color signals. Thus, the occurrence of cross color can be suppressed, and video signals can be transmitted with a high image quality thereof being maintained.

### BRIEF DESCRIPTION OF THE DRAWINGS

FIG. 1 is a diagram illustrating an example of prior art imaging systems;

FIG. 2 is a diagram illustrating another example of prior art imaging systems; and

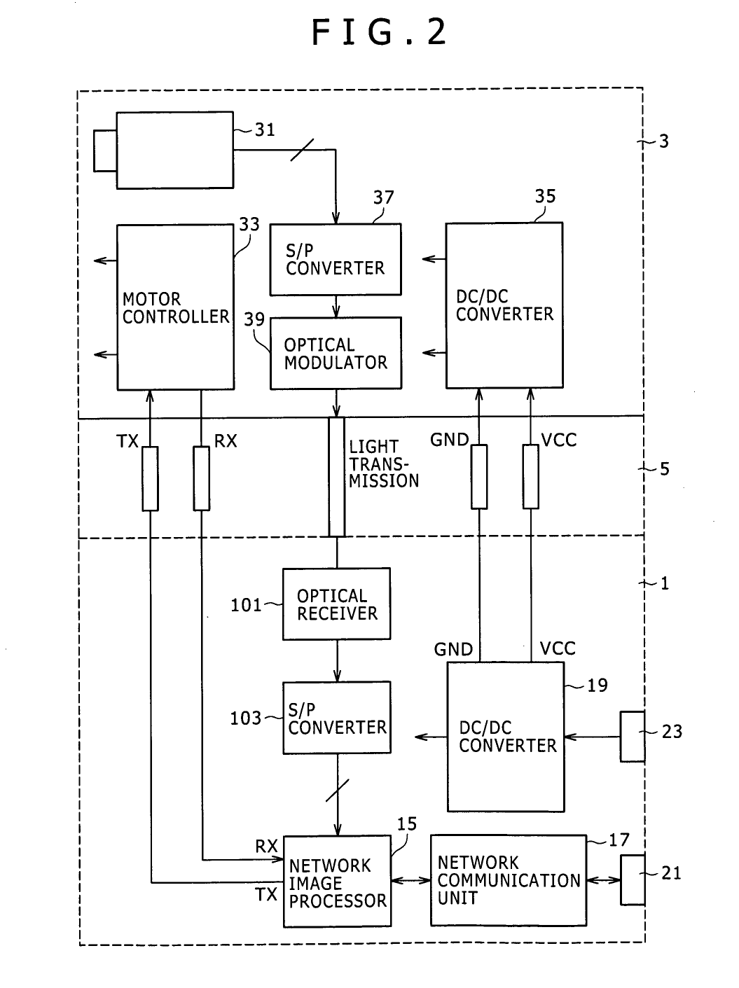

FIG. 3 is a diagram illustrating an imaging system as an embodiment of the invention.

### DETAILED DESCRIPTION OF THE PREFERRED EMBODIMENTS

An embodiment to which techniques according to the invention are applied will be described below.

Part that is not illustrated or described in the present specification may employ well-known or publicly-known techniques in the related technical field.

It should be noted that the following embodiment is merely one embodiment example of the invention, and the invention is not limited thereto.

(A) Embodiment

(A-1) Configuration Example of Imaging System

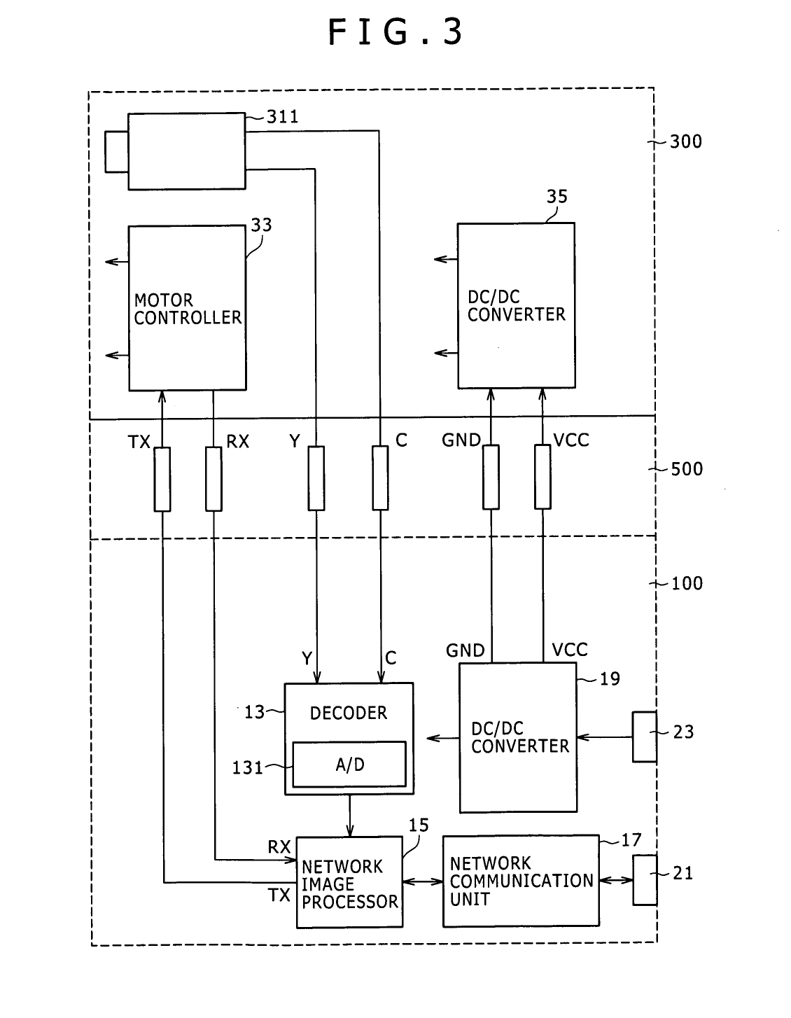

FIG. 3 illustrates a configuration example of a 360° endless rotary imaging system having a network function.

This imaging system includes a stationary base 100, an imaging device 300 that is rotatably attached to the stationary base, and a slip ring 500 that electrically couples the stationary base and the imaging device.

In this embodiment, two kinds of signals of an analog luminance signal and an analog color signal are used for video signal transmission.

Accordingly, the total number of poles in the slip ring 500 is six: two poles for video signals (Y, C), two poles for motor drive signals (TX, RX), and two poles for power supply (GND, VCC).

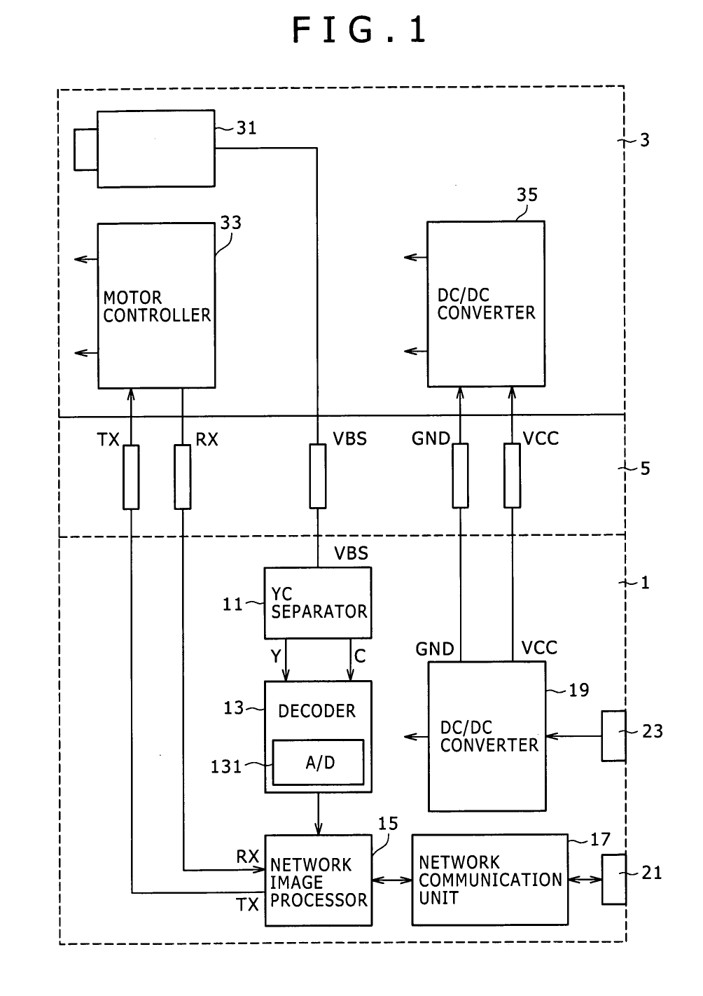

Therefore, the number of poles in the slip ring 500 is larger by one than that in the conventional example of FIG. 1. However, in the slip ring 500, the transmission path for the luminance signals is separated from that for the color signals, which decreases the possibility of occurrence of the cross color.

The stationary base 100 is provided with two input terminals for the video signals of course. In addition, the stationary base 100 includes a decoder 13, a network image processor 15, a network communication unit 17, a DC/DC converter 19, a communication terminal 21, and a power supply terminal 23.

The decoder 13 is a circuit device for decoding analog luminance signals and analog color signals. The decoder 13 incorporates an A/D converter 131 that converts an analog signal into a digital signal. Therefore, video signals in a digital signal format are supplied to the network image processor 15.

The network image processor 15 is a processing unit that sends and receives video signals and control signals to and from an external device coupled to the imaging system via a network. The network image processor 15 is constructed of e.g. a micro processor. In this embodiment, the network image processor 15 outputs to the network communication unit 17 video signals input as digital signals.

Furthermore, in accordance with an operation instruction from an external device, the network image processor 15 outputs to a motor controller 33 a signal for drive-controlling the imaging direction of a camera block 311. The imaging direction is drive-controlled regarding two directions: the horizontal direction and vertical direction.

The network image processor 15 receives from the motor controller 33 a response signal of the drive-control of the imaging direction.

The network communication unit 17 is a communication device that sends and receives data to and from a network coupled to the imaging system via the communication terminal 21. This network may be either of a wired network and a wireless network.

The DC/DC converter 19 is a circuit device for shifting the level of the input voltage supplied via the power supply terminal 23 to the specified value. In this embodiment, the DC/DC converter 19 produces both the supply voltage to be used in the stationary base 100 and the supply voltage to be used in the imaging device 300. In actual, the level of the supply voltage for the imaging device 300 is limited within a range compatible with the breakdown voltage of the slip ring 500.

The supply voltage provided through the slip ring 500 is converted again into the supply voltage for use in the imaging device 300 by a DC/DC converter 35 in the imaging device 300.

The imaging device 300 also includes the camera block 311 and the motor controller 33. The camera block 311 is constructed of an imaging lens, an imaging element, a video signal processing circuit and so on. The camera block 311 separates a captured video signal into an analog luminance signal and an analog color signal, and outputs the separated signals to two transmission paths independent of each other. In terms of this respect, the camera block 311 is different from the camera block 31 in the conventional example of FIG. 1.

The motor controller 33 is a control unit that controls the drive quantities of the respective motors for driving the imaging direction of the camera block 311 along the horizontal and vertical directions.

(A-2) Advantages Achieved by Embodiment

In this embodiment, the number of poles for video signals necessary in the slip ring may be two: a pole for luminance signals and a pole for color signals. Therefore, an imaging system is provided with a slip ring having a less number of terminals compared with a slip ring through which video signals are transmitted as digital signals.

Furthermore, when video signals in an analog signal format are transmitted, there is no need to design a dedicated slip ring having a wide transmission band. This feature, in addition to a less number of poles, allows reduction of manufacturing costs.

In addition, video signals are transmitted, with being separated into analog luminance signals and analog color signals, through different transmission paths in the slip ring of course. Therefore, in this imaging system, image quality deterioration due to cross color is prevented. As a result of the suppression of image quality deterioration, a high image quality obtained at the time of imaging is maintained as it is also when the imaged video signals are placed in secondary use.

(B) Other Embodiments

(a) The above-described embodiment relates to an imaging system coupled to a network, i.e., relates to a network camera system. However, an application example of the invention is not limited thereto.

For example, such a configuration is also available that video signals captured by an imaging system are output to a specific external apparatus via a coaxial cable, a serial cable or the like. In this configuration, as the network image processor 15 and the network communication unit 17, units compliant to the standard of the coupling to the external apparatus are used.

(b) The above-described embodiment relates to a 360° endless rotary imaging system. However, the invention can be applied also to a configuration in which the moving range of the imaging system in the horizontal direction is limited within a certain range.

Furthermore, the above-described embodiment relates to an imaging system of which imaging direction can be driven regarding two directions of the horizontal and vertical directions. However, the invention can be applied also to an imaging system of which imaging direction can be driven only regarding the horizontal direction.

(c) The imaging system according to the above-described embodiment can be applied to a monitoring system, a security system, an industrial camera system, a video conference system, a remote camera system (lecture, speech and other educational objects, imaging of a conference hall, imaging of an event, etc.), and other systems.

(d) In the above-described embodiment, an imaging device, a slip ring and a stationary base are monolithically arranged in one casing. However, it is desirable that the imaging device be detachably attached to the slip ring.

(e) Various modifications might be incorporated into the above-described embodiment without departing from the scope of the invention. In addition, various modifications and applications that are created or combined based on the description of the present specification are also available.

What is claimed is:

1. An imaging system comprising:
a stationary base;
an imaging device that is rotatably attached to the stationary base; and
a rotary coupling unit that electrically couples the stationary base and the imaging device, wherein
an analog luminance signal and an analog color signal are used for transmission of a video signal, and are transmitted through different transmission paths in the rotary coupling unit.

2. The imaging system according to claim 1, wherein
the stationary base includes a network communication unit that sends digitalized image data onto a network.
